(19) United States
(12) Patent Application Publication
(10) Pub. No.: US 2026/0077835 A1
(43) Pub. Date: Mar. 19, 2026

(54) METHOD FOR TRANSFERRING ENERGY STORAGE MEDIUM BETWEEN POWER GENERATION FLOAT AND TRANSPORT VESSEL IN OFFSHORE POWER GENERATION SYSTEM

(71) Applicant: TOYOTA JIDOSHA KABUSHIKI KAISHA, Toyota-shi (JP)

(72) Inventor: Mikikane HIROHATA, Suntou-gun (JP)

(73) Assignee: TOYOTA JIDOSHA KABUSHIKI KAISHA, Toyota-shi (JP)

(21) Appl. No.: 19/198,235

(22) Filed: May 5, 2025

(30) Foreign Application Priority Data
Sep. 18, 2024 (JP) 2024-160807

(51) Int. Cl. B63B 27/30; B63B 27/00; B63B 35/44; H02J 15/00

(52) U.S. Cl. CPC B63B 27/30; B63B 27/19; H02J 15/50; B63B 2035/446; B63B 2035/4466

(57) ABSTRACT

A method of transferring a storage medium loaded on a power generation float from a float that generates electricity on the ocean to a transport vessel on the ocean includes a first process of fixing the power generation float to the transport vessel so that a height of a loading place of the storage medium of the power generation float is higher than a height of a storage place of the storage medium of the transport vessel, a second process of forming a first path in which the storage medium can move between the loading place of the storage medium of the power generation float and the storage place of the storage medium of the transport vessel, and a third process of moving the storage medium from the loading place of the power generation float to the storage place of the transport vessel by gravity through the first path.

### CROSS-REFERENCE TO RELATED APPLICATION

This application claims priority to Japanese Patent Application No. 2024-160807 filed on Sep. 18, 2024. The disclosure of the above-identified application, including the specification, drawings, and claims, is incorporated by reference herein in its entirety.

### BACKGROUND

### 1. Technical Field

The present disclosure relates to a method for transferring a storage medium for energy obtained by a float (power generation float) such as a ship including an offshore generator in an offshore power generation system between a transport vessel and the power generation float on the ocean.

### 2. Description of Related Art

Offshore wind power generation has attracted attention as one of the methods for obtaining renewable energy. On the ocean, there are few restrictions on land and roads, and wind is expected to blow stably in the same direction and with the same strength. The advantage of wind power generation that can stably generate electric power even at night is effectively utilized. For this reason, various technologies related to offshore wind power generation have been proposed. For example, Japanese Unexamined Patent Application Publication No. 2024-80145 (JP 2024-80145 A) proposes an offshore energy collection system including a plurality of floating power generation devices and a platform separated from the floating power generation devices. The floating power generation device includes a microwave power transmission unit that transmits, by microwaves, generated electric power generated in a floating state on the ocean. The platform includes a microwave power reception unit that receives the microwaves transmitted from the microwave power transmission unit of the floating power generation device. The microwave power transmission unit and the microwave power reception unit each include an array antenna in which a plurality of element antennas is arranged. The microwave power transmission unit transmits the transmission power to the microwave power reception unit by a retrodirective operation. The microwave power reception unit receives coherent microwaves that are aligned in frequency and phase from the floating power generation devices.

### SUMMARY

As the types of the offshore power generation system using wind energy and tidal energy, there have been proposed and developed a landing type that is installed in a shallow sea area relatively close to land (a system in which a generator is fixed to the sea bottom), and a floating type that can be deployed in a deeper sea area (a mooring type float that is moored on the ocean to install a generator or a system using a mobile float in which a generator is installed). Of those systems, the floating system is advantageous in that it can utilize a sea area with strong wind and tidal power as appropriate and can therefore efficiently collect energy. Regarding delivery of energy obtained by offshore power generation in the floating system to the energy consumption area, when the target sea area as shallow as 200 m or less and the distance from the coast is 50 km or less, a power transmission cable can be installed from the system to the land. When the water depth is larger than this or the distance from the coast is long, it is difficult to install the cable from the viewpoint of cost. It may also be difficult to transmit electric power by microwaves as in JP 2024-80145 A (the transmission distance may be extremely long). Therefore, the following measures are conceivable. In a sea area where cable installation or microwave transmission is difficult, a battery is charged with electric energy generated by the power generation float. Alternatively, the electric energy is converted to chemical energy retained by hydrogen gas produced through a water decomposition reaction initiated by the energy. The hydrogen gas or liquid hydrogen obtained by liquefying the hydrogen gas is stored in a tank, and the energy is stored in a storage medium (a battery or a hydrogen tank) loaded on the power generation float. A transport vessel is sent to the power generation float as appropriate. The medium storing the energy is transferred from the power generation float to the transport vessel. A medium for storing energy is transferred from the transport vessel to the power generation float. This method is advantageous in that the storage medium can be collected without excessively moving the power generation float from the power generation place on the ocean and the power generation float can secure a longer power generation time.

In the above transfer of the medium between the power generation float and the transport vessel on the ocean, the use of a transfer machine such as a crane (see, for example, Japanese Unexamined Patent Application Publication No. 2001-26393 (JP 2001-26393 A)) is difficult for the following reason. The power generation float and the transport vessel rock separately on the ocean. In particular, when the wave is high, it is difficult to determine the position of the crane at the time of receiving the load. When a rope attached to the storage medium is hung on a hanging hook of the crane installed on a deck of the transport vessel, attended work on the deck is generally required to attach and detach the rope and control the crane. When the storage medium is gripped by a hydraulic hand provided on the crane instead of the hook, there are problems such as difficulty in positioning operation for the hydraulic hand, slippage of the storage medium from the hydraulic hand, and possibility of falling in a situation where the power generation float and the transport vessel rock on the ocean.

In view of the above circumstances, it is a main object of the present disclosure to provide an offshore power generation system in which a storage medium for energy generated by a power generation float can be transferred from the power generation float to a transport vessel without using a transfer machine such as a crane.

According to the present disclosure, the above object is achieved by a method for transferring, from a power generation float configured to generate electric power on an ocean to a transport vessel on the ocean, a storage medium that stores energy obtained through power generation by the power generation float and is loaded on the power generation float. The method includes:
a first process of fixing the power generation float to the transport vessel such that a height of a loading place of the storage medium on the power generation float is larger than a height of a storage place of the storage medium on the transport vessel;
a second process of forming a first path in which the storage medium is movable between the loading place of the storage medium on the power generation float and the storage place of the storage medium on the transport vessel; and
a third process of moving the storage medium from the loading place on the power generation float to the storage place on the transport vessel by gravity through the first path.

In the above configuration, the “power generation float” may be an offshore float including any type of wind power generation system typified by a kite power generation system, or any other offshore power generation system. The “storage medium” is loaded on the power generation float and stores energy obtained by power generation in any form. Specifically, the “storage medium” may be a battery charged with electric energy as it is, or may be a tank that stores hydrogen gas produced through a water decomposition reaction using electric energy obtained by power generation or liquid hydrogen obtained by liquefying the hydrogen gas. In the power generation float, a plurality of storage media may be loaded in a loading place provided as appropriate. At the time of power generation, the power generation system mounted on the power generation float sequentially charges the batteries that are the storage media with the generated electric power. Alternatively, the power generation system sequentially stores the hydrogen gas or the liquefied hydrogen generated using the generated energy in the tanks that are the storage media.

In the above configuration, in the first process, the power generation float is fixed to the transport vessel such that the height of the loading place of the storage medium on the power generation float is larger than the height of the storage place of the storage medium on the transport vessel. In the second process, the first path in which the storage medium is movable is formed between the loading place of the storage medium on the power generation float and the storage place of the storage medium on the transport vessel. In the third process, the storage medium is moved from the loading place on the power generation float to the storage place on the transport vessel by gravity through the first path. Thus, the transfer of the storage medium from the power generation float to the transport vessel can be achieved without the use of the transfer machine such as a crane, and the movement of the storage medium can be achieved unattended or automatically as a result of the gravity.

In the above configuration, the fixing of the power generation float and the transport vessel may be performed in any manner. For example, in a case where the transport vessel has a single-hull structure, a magnet may be provided at a portion of the edge of the transport vessel with which the edge of the power generation float comes into contact, and the power generation float may be fixed to the transport vessel by the magnetic force. In a case where the transport vessel has a twin-hull structure, the power generation float may be caused to enter the space between the two hulls, elastic bodies may be provided at portions of the facing outer edges of the two hulls with which the edge of the power generation float comes into contact, and the power generation float may be fixed to the transport vessel by the elastic force.

In the above configuration, a stopper member may be provided to hold the storage medium at the loading place of the storage medium such that the storage medium does not fall from the power generation float during the energy generation in the power generation float and during the storage in the storage medium. The stopper member is displaced in the second process to form at least part of the first path for movement of the storage medium. Accordingly, the stopper member for preventing the storage medium from falling is diverted to form the path for movement of the storage medium, and the number of components can be reduced. The stopper member may, for example, be configured to form a guide rail for movement of the storage medium. When the stopper member is converted to at least part of the first path, the storage medium may automatically start to move from the loading place on the power generation float to the storage place on the transport vessel by gravity.

Transportation of a storage medium having capacity to store energy or an empty storage medium to the power generation medium may also be achieved by the transport vessel. In this case, it is also preferable that the transfer of the storage medium from the transport vessel to the power generation float can be achieved without using the transfer machine such as a crane.

In addition to the above configuration, in the first process, the power generation float is fixed to the transport vessel such that a height of a loading place of the storage medium having capacity to store energy or the empty storage medium on the transport vessel is larger than the height of the loading place of the storage medium on the power generation float. After the third process, a fourth process and a fifth process may be performed. In the fourth process, a second path in which the storage medium is movable is formed between the loading place of the storage medium having capacity to store energy on the transport vessel and the loading place of the storage medium on the power generation float. In the fifth process, the storage medium is moved from the loading place on the transport vessel to the loading place on the power generation float by gravity through the second path.

The transfer of the storage medium from the transport vessel to the power generation float may be performed regardless of whether the above configuration is present. Therefore, according to another aspect of the present disclosure, there is provided a method for transferring, from a transport vessel on an ocean to a power generation float configured to generate electric power on the ocean, a storage medium having capacity to store energy and to be loaded on the power generation float to store energy obtained through power generation by the power generation float. The method includes:
a sixth process of fixing the power generation float to the transport vessel such that a height of a loading place of the storage medium on the transport vessel is larger than a height of a loading place of the storage medium on the power generation float;
a seventh process of forming a second path in which the storage medium is movable between the loading place on the transport vessel and the loading place on the power generation float; and
an eighth process of moving the storage medium from the loading place on the transport vessel to the loading place on the power generation float by gravity through the second path.

A stopper member configured to prevent the storage medium from falling may be provided at the edge of the loading place of the transport vessel, and the stopper member may be displaced in the fourth process or the seventh process to form at least part of the second path.

In the series of configurations described above, the storage medium may have a cylindrical shape and may be configured to automatically move between the power generation float and the transport vessel by rolling due to gravity. The storage medium may be covered with a shock absorber on its periphery to reduce a shock during movement.

Thus, the transfer of the energy storage medium between the power generation float and the transport vessel in the offshore power generation system can be achieved without using the transfer machine such as a crane. In the present disclosure, when the path of the storage medium is formed between the power generation float and the transport vessel, the height of the loading place of the storage medium is larger than the height of the transfer place. Thus, the storage medium automatically moves by gravity. There is no operation such as hanging the rope attached to the storage medium on the hanging hook of the crane that was necessary when the crane was receiving the load. Normally, there is no need for operations to attach and detach the rope or control the crane that require attended work on the deck. It is expected that the transfer of the storage medium can be achieved unattended and automatically.

Other objects and advantages of the present disclosure will become apparent from the following description of preferred embodiments of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic view of a power generation float used in an offshore wind power generation system according to an embodiment of the present disclosure;

FIG. 1B is a schematic side view of a storage medium used for storing energy in the power generation float;

FIG. 1C is a schematic front view of a storage medium used for storing energy in the power generation float;

FIG. 2A is a schematic cross-sectional view of a transport vessel and a power generation float illustrating a transfer state of a storage medium between a transport vessel and a power generation float according to the present embodiment, wherein the power generation float is positioned between the hulls of the transport vessel;

FIG. 2B is a schematic cross-sectional view of a transport vessel and a power generation float illustrating how the storage medium is transferred between the transport vessel and the power generation float of the catamaran structure in the present embodiment, showing a condition for transferring the stored energy storage medium from the power generation float to the transport vessel;

FIG. 2C is a schematic cross-sectional view of a transport vessel and a power generation floating structure illustrating how the storage medium is transferred between the transport vessel and the power generation float of the catamaran structure in the present embodiment, showing a condition for transferring energy-storable or empty storage medium from the transport vessel to the power generation float;

FIG. 3A is a schematic top view of a transport vessel and a power generation float illustrating a transfer state of a storage medium between a transport vessel and a power generation float of a twin-hull ship structure according to an embodiment of the present disclosure, and shows a case where an energy storable or empty storage medium is transferred from the transport vessel to the power generation float after transfer of the stored storage medium of energy from the power generation float to the transport vessel;

FIG. 3B is a schematic top view of a transport vessel and a power generation float illustrating a transfer state of a storage medium between a transport vessel and a power generation float according to an embodiment of the present disclosure, and shows a state after transfer of an energy-storable or empty storage medium from the transport vessel to the power generation float (the deck part is omitted);

FIG. 4A is a schematic cross-sectional view of a transport vessel and a power generation float illustrating a transfer state of a storage medium between a transport vessel and a power generation float according to the present embodiment; and

FIG. 4B is a schematic top view of a transport vessel and a power generation float illustrating a transfer state of a storage medium between a transport vessel and a power generation float according to the present embodiment.

### DETAILED DESCRIPTION OF EMBODIMENTS

The disclosure will now be described in detail in accordance with some preferred embodiments with reference to the accompanying drawings, in which: In the drawings, the same reference numerals denote the same parts.

### Configuration of Power Generation Float and Storage Medium

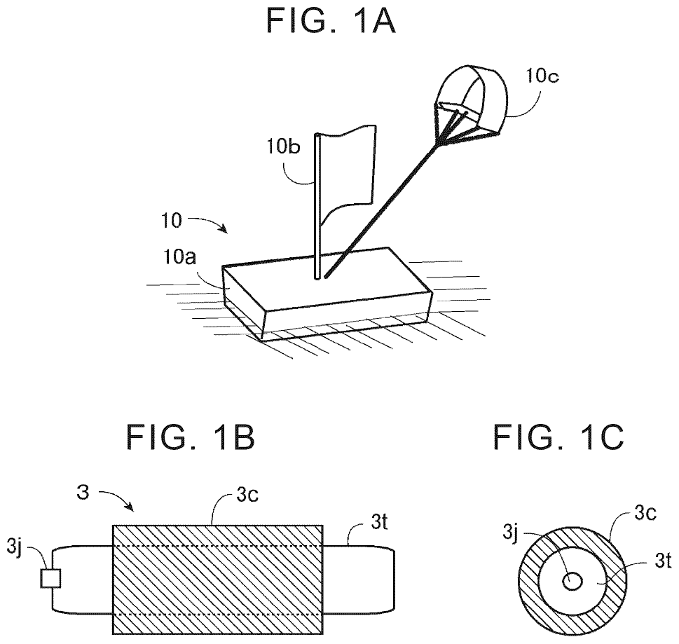

The method according to the present embodiment is applied to the offshore transfer of an energy storage medium between a transport vessel and a power generation float in an offshore power generation system. The offshore power generation system may in particular be any type of wind power generation system or other power generation system (such as a tidal current, tidal power-based system) that is implemented offshore. In such a system, the power generation float is configured to move to a location on the ocean where it can generate better to perform power generation and store the resulting energy in a storage medium in any manner. As the power generation float, for example, a float 10 may be adopted in which a sale 10b or the like for driving is provided on a float body 10a floating on the ocean as schematically depicted in FIG. 1A, and a kite generator 10c is mounted. The power generated is stored in a storage medium (not shown) that is appropriately loaded on the body 10a.

As a method of storing energy, as already mentioned in the Summary of the disclosure, electric energy obtained by power generation is converted into hydrogen energy (chemical energy of hydrogen molecules) by generation of hydrogen gas by a water decomposition reaction. Energy may be stored by compressing or liquefying hydrogen gas that retains energy and storing it in a tank. In this case, the storage medium is a hydrogen tank. Alternatively, in another embodiment, the resulting electrical energy may be stored by charging the battery. In this case, the storage medium is a battery.

In the method according to the present embodiment, the storage medium is configured to move with gravity between the power generation float and the transport vessel, as already mentioned in the Summary section of the disclosure, but is preferably configured to roll with gravity, as described below. Thus, as depicted in FIG. 1B, and 1C, the storage medium 3 may comprise a cylindrical body 3t and a cushioning material 3c (which may be made of rubber having a lower coefficient of repulsion or the like) wound around it, and an inlet 3j for injecting electric power or hydrogen gas or liquid hydrogen may be provided at the front end of the body 3t. When the substance actually stored in the storage medium 3 is hydrogen gas or liquid hydrogen, the body 3t may be, for example, a high-pressure container made of carbon, and during power generation, the inlet 3j may be connected to a pipe for hydrogen, and hydrogen gas or liquid hydrogen may be injected into the tank.

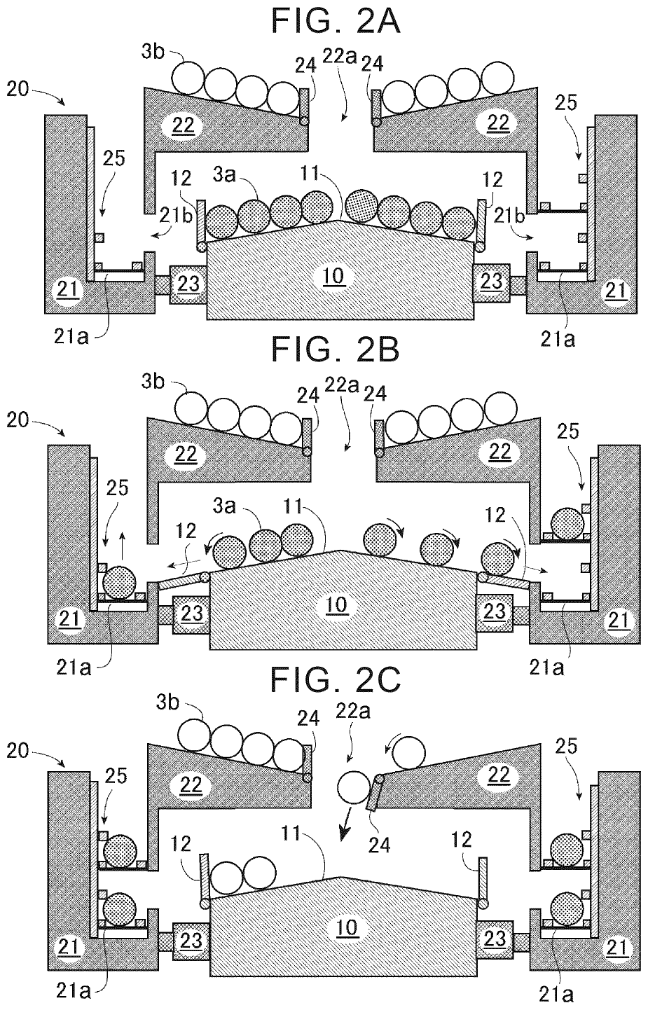

Further, as schematically illustrated in FIG. 2A, the storage medium 3 may be stacked on the deck 11 on the body 10a in the power generation float 10. That is, in the power generation float 10, the deck 11 is the loading place of the storage medium 3. As shown in the drawing, the deck 11 is provided at an outer edge thereof with a stockade-shaped stopper member 12 in a pivotably upright state. At least one outer edge is inclined to be lower than the inside of the deck 11. The cylindrical central axis of the storage medium 3 is juxtaposed so as to extend in a direction perpendicular to the direction from the inclined inner side to the outer edge of the deck 11. Thus, when the stopper member 12 is in an upright state, the storage medium 3 is held in a stacked state on the deck 11, and when it is displaced downward from the horizontal direction, the storage medium 3 is automatically rolled by the gravitational force and is movable from the outer edge to the outside.

### Composition of Transport Vessel

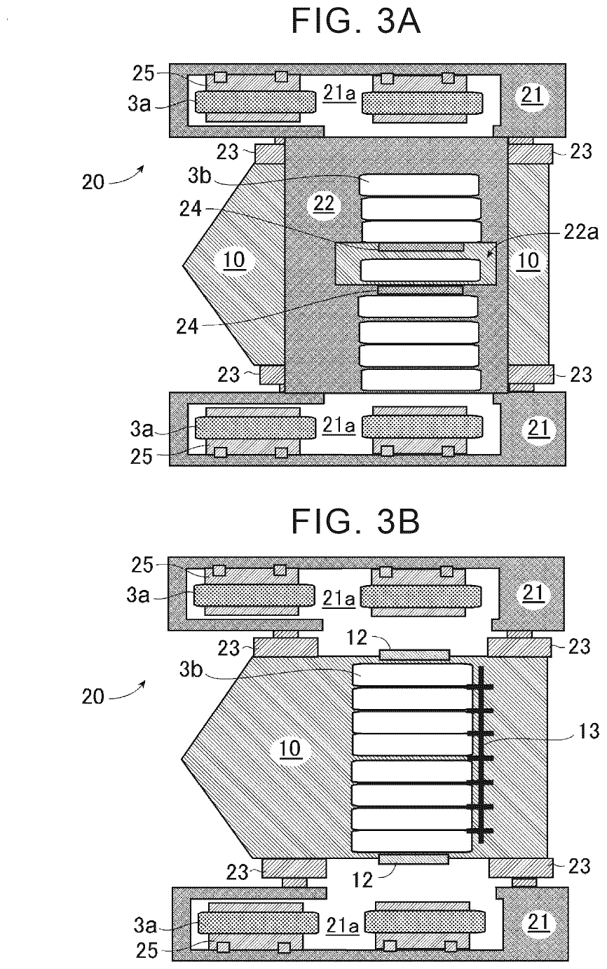

As described above, in the method of the present embodiment, the transport vessel is sent to the power generation float 10 on the ocean, and the storage medium is transferred between the power generation float 10 and the transport vessel on the ocean. The transport vessel used in this case may in one embodiment be a catamaran-structured vessel in which two parallel hulls 21 are connected by a deck part 22, as schematically depicted in FIGS. 2A to 3B. As shown in the figure, the storage place 21a of the storage medium 3a received from the power generation float 10 is provided in each of the two hulls 21, and the loading place of the storage medium 3b to be transferred to the power generation float 10 is provided on the deck part 22. Here, the storage medium 3a received by the transport vessel 20 from the power generation float 10 is usually a storage medium in which energy is stored, and the storage medium 3b passed by the transport vessel 20 to the power generation float 10 is usually a storage medium in which energy is storable or empty. Further, the respective hulls 21 are provided with openings 21b through which the storage medium 3a from the power generation float 10 passes. The storage media 3a storage place 21a may be equipped with an alignment mechanism 25, such as a belt conveyor, for appropriately aligning the storage media 3a received from the power generation float 10. On the other hand, in the deck part 22 serving as the loading place of the storage medium 3b, an opening 22a for dropping the storage medium 3b onto the deck 11 of the power generation float 10 is formed therefrom, as will be described later. The upper surface of the deck part 22 is inclined downward toward the opening 22a. A fence-shaped stopper member 24 is provided at the edge of the opening 22a in a pivotably upright position. The storage medium 3b is then juxtaposed such that its cylindrical central axis extends in a direction perpendicular to the direction towards the edge of the inclined opening 22a of the deck part 22. Accordingly, when the stopper member 24 is in the upright state, the storage medium 3b is held in the stacked state on the deck part. When the stopper member 24 is displaced downward, the storage medium 3b automatically rolls due to its gravitational force and can fall downward from the opening 22a.

In addition, in the case of the transport vessel 20 having the twin-hull structure illustrated in FIGS. 2A and 3B, when the storage medium 3 is delivered, the power generation float 10 is caused to enter between the two hulls 21 below the deck part 22. In order to position the power generation float 10 with respect to the two hulls 21, a float fixing portion 23 is provided on the opposite sides of the two hulls 21. The float fixing portion 23 abuts on the side portion of the body 10a of the power generation float 10 while applying a pressing force such as a rubber-elastic force or a magnetic force when the power generation float 10 enters the lower portion of the deck part 22. The power generation float 10 can be held between the two hulls 21.

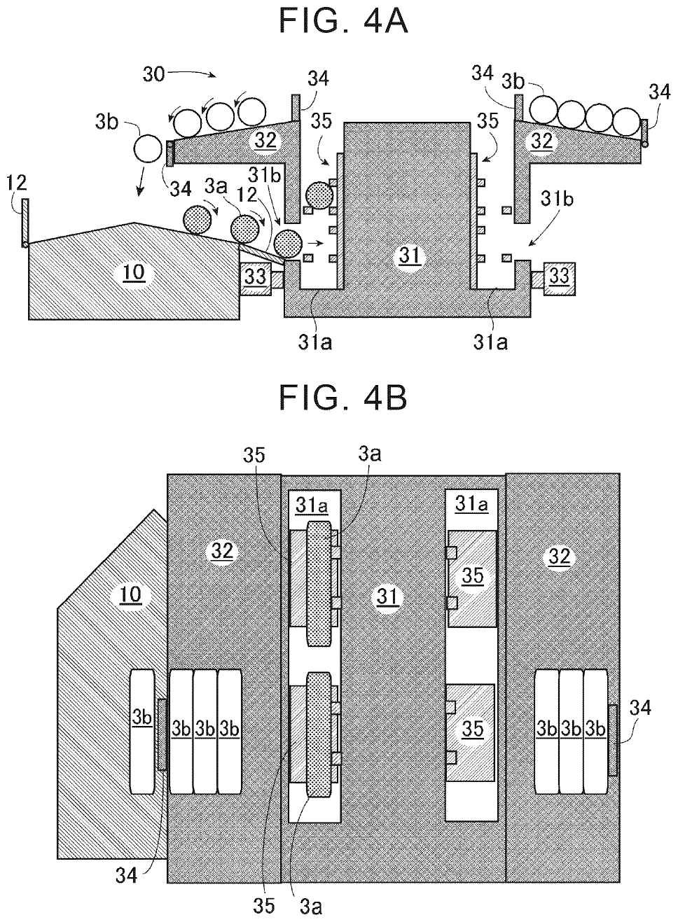

In another aspect of the transport vessel utilized in the methods of the present embodiments, the transport vessel 30 may be of a single-hull construction, as illustrated in FIGS. 4A and 4B. Again, the hull 31 is provided with a storage place 31a for the storage medium 3a. An opening 31b through which the storage medium 3a received from the power generation float 10 passes is formed on the upper side thereof. In the storage place 31a, mechanisms 35 for aligning the storage medium 3a as appropriate may be provided. In addition, the deck part 32 of the hull 31 protrudes outward from the hull 31 and is inclined in a direction decreasing toward the outer edge, and the fence-shaped stopper member 34 is provided on the outer edge in a pivotably upright state. The storage medium 3b is then juxtaposed such that its cylindrical central axis extends in a direction perpendicular to the direction towards the outer edge of the deck part 32. As a result, as illustrated in FIG. 4A, when the stopper member 34 is in the upright state, the storage medium 3b is held in the stacked state on the deck part 32. When the stopper member 34 is displaced downward, as illustrated in left-hand side of FIG. 4A, the storage medium 3b automatically rolls due to its gravitational force and can fall downward from the outer edge. Further, in the case of the transport vessel 30 having the single-hull ship structure illustrated in FIG. 4, when the storage medium 3 is delivered, the power generation float 10 is positioned below the outer edge of the deck part 32 and is brought into contact with the side portion of the hull 31. A float fixing portion 33 is provided to position the power generation float 10 with respect to the hull 31. The float fixing portion 33 may be configured to apply an attractive force such as a magnetic force to a side portion of the body 10a of the power generation float 10 so that the power generation float 10 can remain in contact with the hull 31.

### Transfer of Storage Media Between Power Generation Float and Transport Vessel

In the method of the present embodiment, as described above, when the storage medium is transferred between the power generation float and the transport vessel, the storage medium is automatically moved from the transfer source to the transfer destination by gravity without using a transfer machine such as a crane. To this end, first, in order to transfer the storage medium 3a from the power generation float 10 to the transport vessels 20 and 30, the loading place (deck 11) of the storage medium 3a of the power generation float 10 is placed at a position higher than the storage place 21a, 31a of the storage medium 3a of the transport vessels 20 and 30. Thereby, a movable path of the storage medium 3a is formed between them. The storage medium 3a is automatically moved by gravitational force along its path from the loading place of the power generation float 10 (deck 11) to the storage place 21a, 31a of the transport vessels 20, 30. Further, in order to transfer the storage medium 3b from the power generation float 10 to the transport vessels 20 and 30, the deck parts 22 and 32, which are the loading places of the storage medium 3b of the transport vessels 20 and 30, are placed at positions higher than the loading places (deck 11) of the storage medium 3b of the power generation float 10. Thereby, a movable path of the storage medium 3b is formed between them. The storage medium 3b is automatically moved by gravitational force along its path from the deck parts 22, 32 of the transport vessels 20, 30 to the loading place (deck 11) of the power generation float 10. Hereinafter, a series of processes will be described in order.

In the transfer of the storage medium between the power generation float 10 and the transport vessel, the power generation float 10 is fixed to the transport vessels 20 and 30 as illustrated in FIGS. 2A and 4A. In this process, as shown in FIG. 2A, when the transport vessel is the transport vessel 20 having a twin-hull structure, the power generation float 10 enters between the two hulls 21 as described above. Thereafter, the float fixing portions 23 abut against both sides of the power generation float 10 from the side portions of the two hulls 21. A pressing force is applied to hold the power generation float 10. Further, as shown in FIG. 4A, when the transport vessel is the transport vessel 30 having a single-hull structure, the attractive force is applied from the float fixing portion 23 to the side portion of the power generation float 10 so that the power generation float 10 comes into contact with the side portion of the transport vessel 30. At this time, the position of the power generation float 10 with respect to the transport vessels 20 and 30 is determined such that the deck 11 on the storage medium 3a of the power generation float 10 is located at a position higher than the storage medium 3a storage place 21a, 31a of the transport vessels 20 and 30, and the deck parts 22 and 32, which are the loading places of the storage medium 3b of the transport vessels 20 and 30, are located at a position higher than the loading places (deck 11) of the storage medium 3b of the power generation float 10.

As described above, the position of the power generation float 10 is determined with respect to the transport vessels 20 and 30. Then, as shown in FIGS. 2B and 4A, the stopper members 12 and 22, which are standing upright at the outer edge of the deck 11 of the power generation float 10 and restraining the movement of the storage medium 3a, pivot. Its distal end is close to the lower edge of the opening 21b, 31b on the side of the hull 21, 31. As a result, the stopper member 12 forms a path that serves as a guide rail that descends from the deck 11 of the power generation float 10 to the storage place 21a, 31a of the transport vessels 20 and 30. As a result, as shown in the figure, the storage medium 3a on the deck 11 naturally rolls and moves to the storage place 21a, 31a of the transport vessels 20 and 30. In the storage place 21a, 31a, as described above, the storage medium 3a that arrive in sequence may be appropriately moved in sequence in the hulls 21 and 31 by the alignment mechanisms 25 and 35.

The transfer of the storage medium 3a on the deck 11 of the power generation float 10 to the storage place 21a, 31a of the transport vessels 20, 30 is completed. Then, as shown in FIG. 2C, the stopper member 12 pivots back to the upright position. Thereafter, as shown in the upper left of FIGS. 2C and 4A, the stopper members 24 and 34 standing at the deck parts 22 and 32 of the transport vessels 20 and 30 are pivoted and their tips are displaced downward. As a result, a path is formed from the deck parts 22 and 32 of the transport vessels 20 and 30 to the deck 11 of the power generation float 10. As a result, the storage medium 3b stacked on the deck parts 22 and 32 of the transport vessels 20 and 30, as shown in FIGS. 2C, 3A, and 4A, naturally roll and fall, and move to the deck 11. Since the deck 11 is inclined downward toward the outer edge, the storage medium 3b naturally rolls toward the outer edge on the deck 11 and is aligned. Thus, as shown in FIG. 3B, when the transfer of the storage medium 3b on the deck parts 22 and 32 to the deck 11 of the power generation float 10 is completed (the member 13 that restricts the movement of the storage medium 3b on the deck 11 may be provided), the transfer of the storage medium between the power generation float 10 and the transport vessel is completed, the action of the float fixing portion 23 that has fixed the power generation float 10 is released, and the power generation float 10 and the transport vessels 20 and 30 are separated from each other.

When the storage medium 3a is not loaded on the power generation float 10, only the transfer of the storage medium 3b from the deck parts 22 and 32 of the transport vessels 20 and 30 to the deck 11 of the power generation float 10 may be executed, and this also falls within the scope of the present embodiment.

Thus, according to the present embodiment described above, the movement of the storage medium between the power generation float and the transport vessel is achieved by gravity of the storage medium. The use of a transfer machine such as a crane is not necessary. Unmanned, offshore delivery of the storage medium between the power generation float 10 and the transport vessel is achievable.

While the above description has been made in connection with embodiments of the present disclosure, many modifications and changes will readily occur to those skilled in the art. The disclosure is not limited to the embodiments illustrated above, but may be applied to various devices without departing from the inventive concept.

What is claimed is:

1. A method for transferring, from a power generation float configured to generate electric power on an ocean to a transport vessel on the ocean, a storage medium that stores energy obtained through power generation by the power generation float and is loaded on the power generation float, the method comprising:
a first process of fixing the power generation float to the transport vessel such that a height of a loading place of the storage medium on the power generation float is larger than a height of a storage place of the storage medium on the transport vessel;
a second process of forming a first path in which the storage medium is movable between the loading place of the storage medium on the power generation float and the storage place of the storage medium on the transport vessel; and
a third process of moving the storage medium from the loading place on the power generation float to the storage place on the transport vessel by gravity through the first path.

2. The method according to claim 1, wherein:
in the first process, the power generation float is fixed to the transport vessel such that a height of a loading place of the storage medium having capacity to store energy on the transport vessel is larger than the height of the loading place of the storage medium on the power generation float; and
the method includes, after the third process:
a fourth process of forming a second path in which the storage medium is movable between the loading place of the storage medium having capacity to store energy on the transport vessel and the loading place of the storage medium on the power generation float; and
a fifth process of moving the storage medium from the loading place on the transport vessel to the loading place on the power generation float by gravity through the second path.

3. The method according to claim 1, wherein a stopper member configured to prevent the storage medium from falling is provided at an edge of the loading place on the power generation float, and the stopper member is displaced in the second process to form at least part of the first path.

4. A method for transferring, from a transport vessel on an ocean to a power generation float configured to generate electric power on the ocean, a storage medium having capacity to store energy and to be loaded on the power generation float to store energy obtained through power generation by the power generation float, the method comprising:
a sixth process of fixing the power generation float to the transport vessel such that a height of a loading place of the storage medium on the transport vessel is larger than a height of a loading place of the storage medium on the power generation float;
a seventh process of forming a second path in which the storage medium is movable between the loading place on the transport vessel and the loading place on the power generation float; and
an eighth process of moving the storage medium from the loading place on the transport vessel to the loading place on the power generation float by gravity through the second path.

5. The method according to claim 1, wherein the storage medium has a cylindrical shape, is covered with a shock absorber on a periphery of the storage medium, and is configured to move by rolling due to gravity.
